(19) United States
(12) Patent Application Publication
(10) Pub. No.: US 2011/0132149 A1
(43) Pub. Date: Jun. 9, 2011

(54) RATCHET WRENCH

(76) Inventor: Tuan-Jung LEE, Dali City (TW)

(21) Appl. No.: 12/629,895

(22) Filed: Dec. 3, 2009

(51) Int. Cl. B25B 13/46

(52) U.S. Cl. 81/63.1

(57) ABSTRACT

A ratchet wrench includes a wrench body having an action end with a housing space formed thereon to hold a ratchet wheel, and two siding troughs located at two sides of the housing space to hold two brake members, and a latch member located at the rear side of the housing space. A direction control member is hinged on the rear side of the housing space and includes a swinging bar, a position member and a stirring bar that are stacked in a up and down manner. The stirring bar can be turned to move the position member and the swinging bar concurrently. The position member is latched by the latch member and positioned. The swinging bar can push the slider at one side to move the brake member forwards to engage with ratchet teeth while another brake member at another side is moved rearwards to separate the ratchet wheel.

### FIELD OF THE INVENTION

The present invention relates to a driving tool and particularly to a ratchet wrench capable of switching driving directions.

### BACKGROUND OF THE INVENTION

A conventional ratchet wrench, referring to FIGS. 1 and 2, mainly includes a wrench body 1 with an annular housing space 2 formed at a front end to hold a ratchet wheel 3 and sealed by a covering lid. The ratchet wheel 3 has an action portion 4 at one side. The housing space 2 also holds two latch members 5 and two springs 6 on a rear side. The two latch members 5 are interposed by a stirring knob 7 which has a rear end hinged on the covering lid. The stirring knob 7 is a strut with a fan-shaped stirring portion 8 formed on the periphery and a stirring bar 9 located at one end of the stirring portion 8. The two springs 6 push the two latch members 5 inwards from outer sides so that inner walls of the two latch members 5 butt the outer walls of the stirring portion 8. By twisting the stirring bar 9 leftwards or rightwards, the stirring portion 8 can be turned. Then the latch member 5 at one side is pushed by the spring 6 and its front end can engage with the ratchet wheel 3.

In practice, the stirring knob 7 can only turn leftwards or rightwards to provide direction change without providing position function. When the springs 6 have elastic fatigue after a period of time, the stirring portion 8 is switchable leftwards or rightwards, but cannot provide position or brake function. There is still room for improvement.

### SUMMARY OF THE INVENTION

Therefore, the primary object of the present invention is to provide a ratchet wrench that is operable simply and also provides secure direction switching and positioning.

To achieve the foregoing object, the ratchet wrench according to the present invention includes a wrench body, a ratchet wheel, two brake members, two sliders, two elastic elements extensible axially and a direction control member.

The wrench body has a handle portion at a rear side and an action end at a front side. The action end is annular and has a housing space formed therein, and two sliding troughs respectively formed at two sides of the housing space, and an elastically extensible latch member embedded axially at a rear side of the housing space.

The ratchet wheel is held in the housing space and has a plurality of ratchet teeth formed on the circumference and an action portion jutting from the top surface thereof.

The brake members are elongated and held in the sliding troughs with a ratchet teeth portion formed at a front side engageable with the ratchet wheel.

The direction control member includes a swinging bar, a position member and a stirring bar located above the position member. The stirring bar drives the position member and the swinging bar to turn. The swinging bar has two ends on the left and right sides hinged on the rear side of the sliders. The position member is located between the swinging bar and the stirring bar and has two concave notches on the periphery with their directions switchable with the position bar. Hence the position member and the swinging bar are turnable together, and the two concave notches can be latched by the latch member for positioning.

The present invention further has a covering lid to cover the top of the housing space to seal the ratchet wheel, brake members, sliders and the swinging bar and position member of the direction control member inside, while the stirring bar and action portion are exposed outside the covering lid.

By means of the construction set forth above, the ratchet wheel is held in a secured position condition to allow the wrench turnable to drive in one direction as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional ratchet wrench.

FIG. 2 is a schematic view of a conventional ratchet wrench in an assembled condition.

FIG. 3 is an exploded view of an embodiment of the present invention.

FIG. 4A is a plane view of an embodiment of the present invention.

FIG. 4B is a schematic view according to FIG. 4A in an operating condition.

FIG. 5A is a fragmentary schematic view of an embodiment of the present invention.

FIG. 5B is a schematic view according to FIG. 5A in an operating condition.

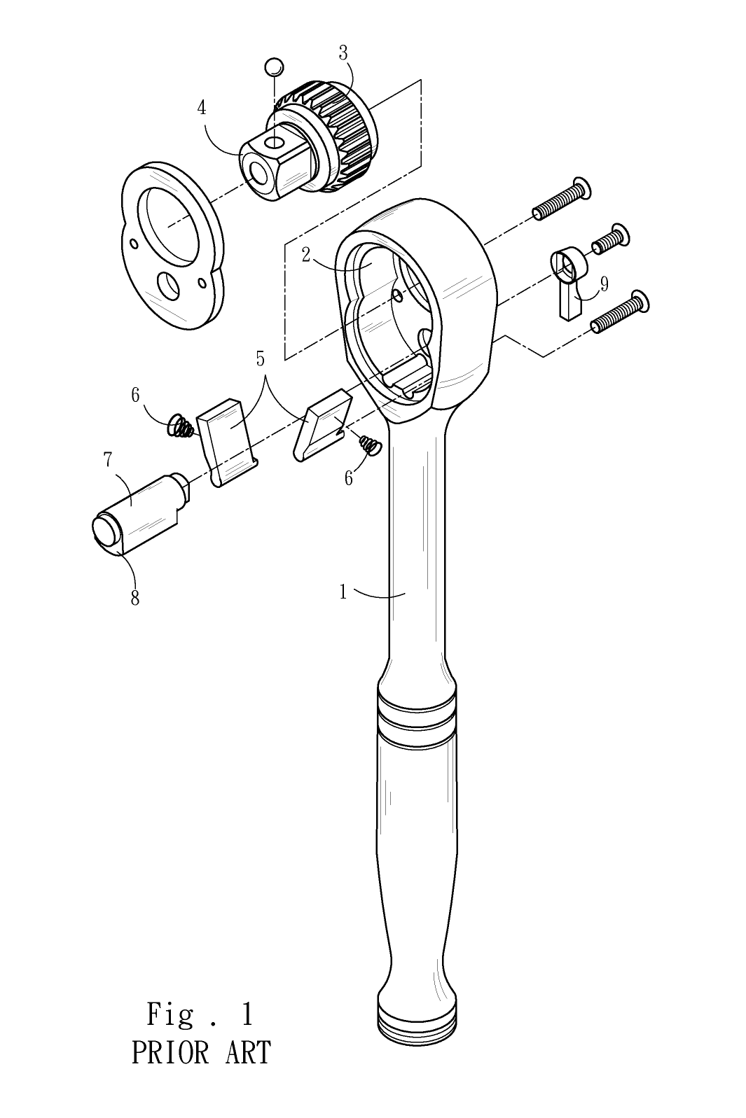

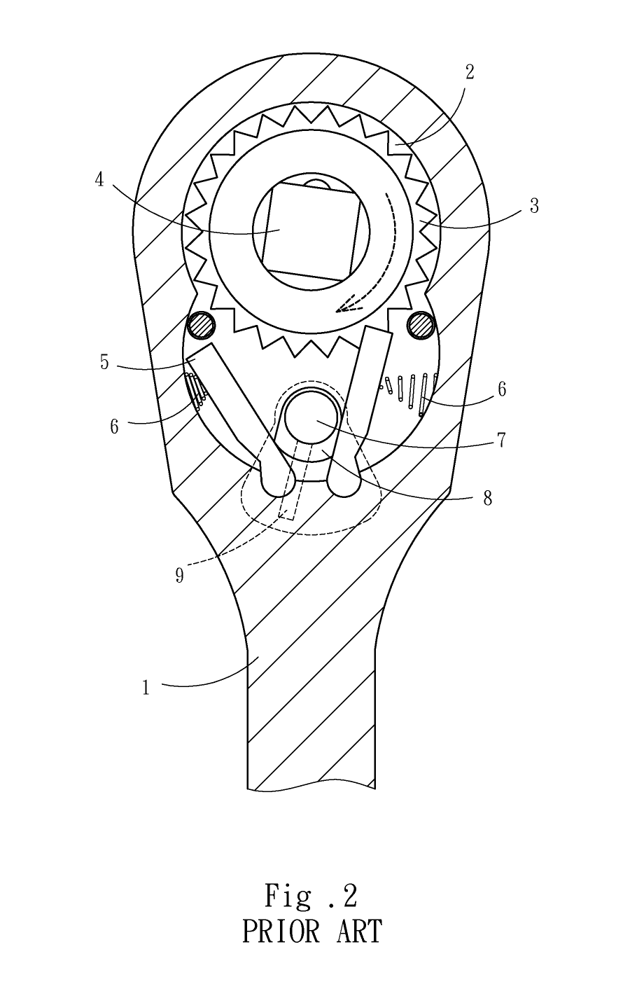

### DETAILED DESCRIPTION OF THE PREFERRED EMBODIMENT

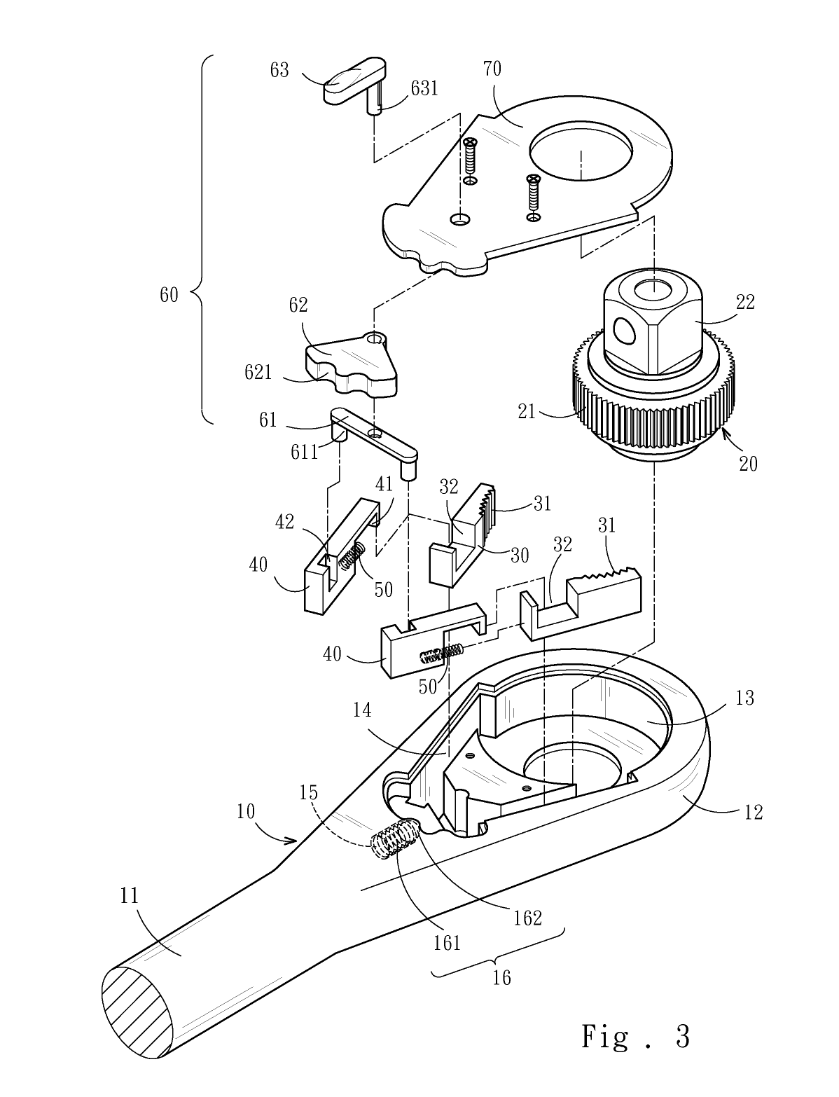

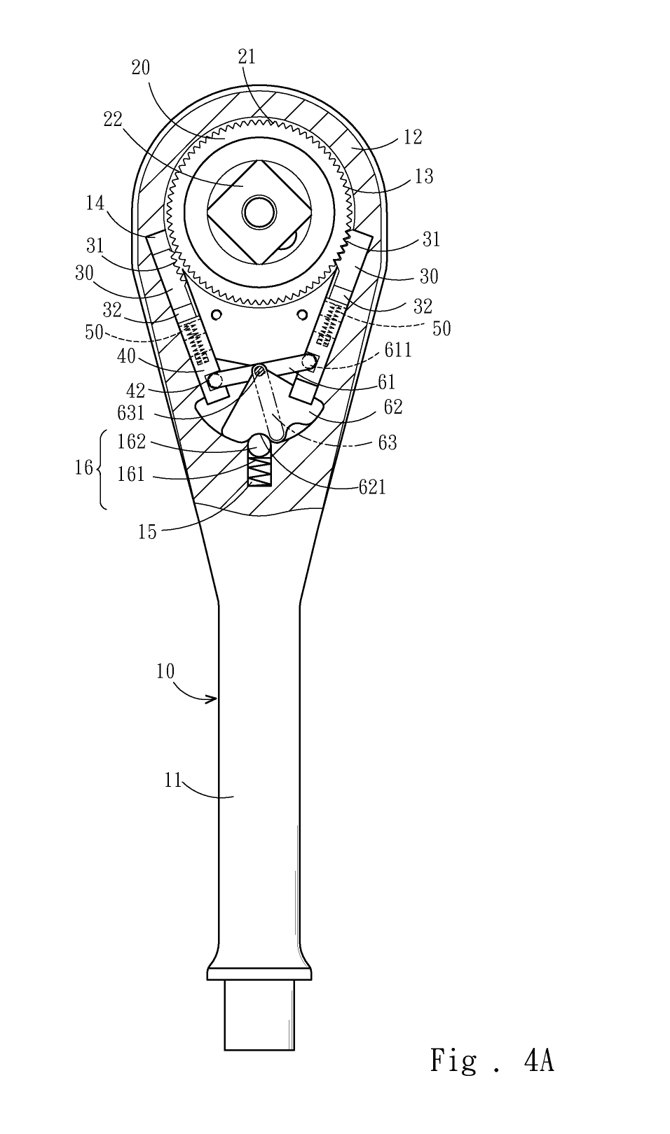

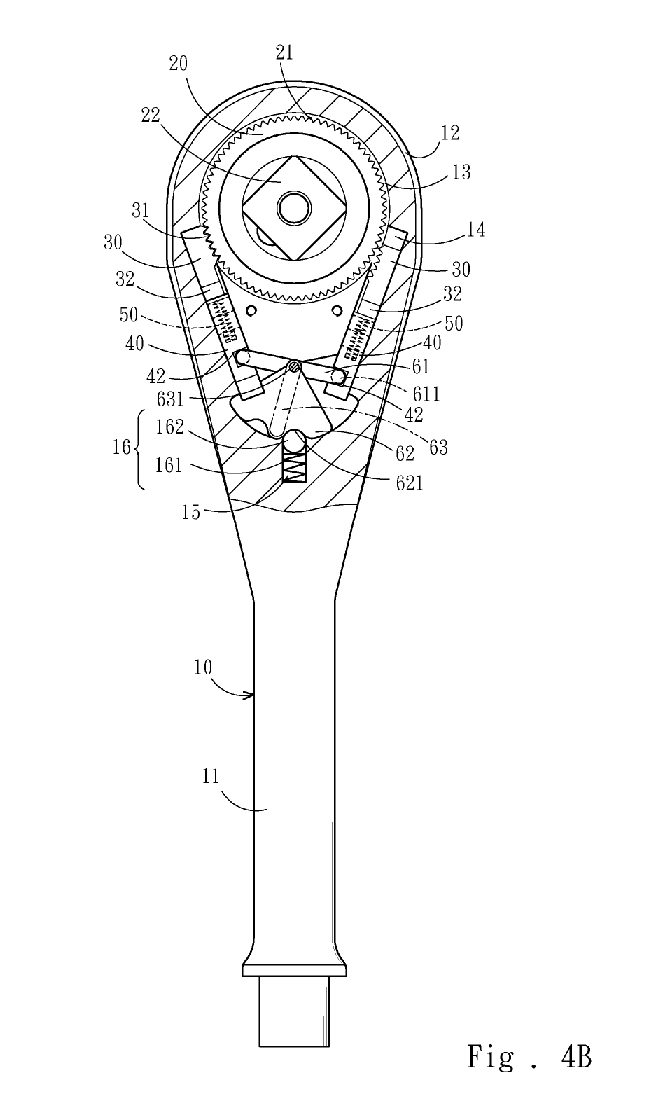

Please refer to FIGS. 3 and 4A, the ratchet wrench according to the present invention includes a wrench body 10, a ratchet wheel 20, two brake members 30, two sliders 40, two elastic elements 50 extendable axially and a direction control member 60.

The wrench body 10 has a handle portion 11 at a rear side and an action end 12 at a front side. The action end 12 is annular and has a housing space 13 formed therein, and two sliding troughs 14 respectively formed on the left side and right side of the housing space 13. The wrench body 10 further has an axial cavity 15 at the rear side of the housing space 13 to hold a latch member 16. The latch member 16 includes an elastic element 161 (such as a spring) held in the cavity 15 and can be extensible axially, and a ball 162 pushed by the elastic element 161 to be partially exposed the housing space 13.

The ratchet wheel 20 is held in the housing space 13 with a plurality of ratchet teeth 21 formed on the circumference and an action portion 22 jutting outwards from the center of the top surface thereof. The action portion 22 is preferably a square strut.

The brake members 30 are elongated and held in the sliding troughs 14 with a ratchet teeth portion 31 formed at a front end engageable with the ratchet wheel 20, and a retaining slot 32 formed at a rear side with an opening directing upwards.

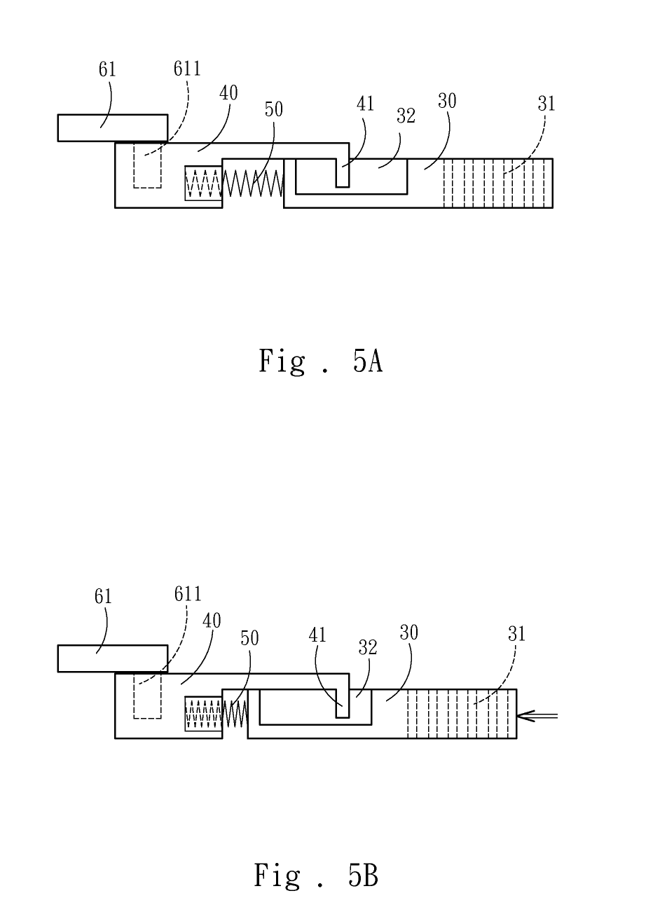

The sliders 40 are elongated and held in the sliding troughs 14 adjacent to the brake members 30, and have respectively a hook 41 directing downwards corresponding to the retaining slot 32. The hook 41 can be hooked with the retaining slot 32 as shown in FIGS. 5A and 5B. Each slider 40 further has a holding trough 42 at the rear side.

The elastic elements 50 are located between the brake members 30 and the sliders 40 and each has a rear end embedded in the slider 40 and a front end pushing a rear wall of the retaining slot 32.

The direction control member 60 includes a swinging bar 61 and a fan-shaped position member 62 that are stacked in an up and down manner, and a stirring bar 63 located above the position member 62. The swinging bar 61 has bosses 611 respectively located below two ends on the left and right sides thereof, and each boss 611 is coupled with the holding trough 42. The position member 62 is located between the swinging bar 61 and the stirring bar 63 and has two concave notches 621 on the periphery at the rear side. The stirring bar 63 has a turning strut 631 located below a front end thereof to nm through the position member 62 and the swinging bar 61 so that the stirring bar 63 can be turned in a selected direction to make the position member 62 and the swinging bar 61 also to change directions with the stirring bar 63. As a result, the position member 62 and the swinging bar 61 are turned at the same time. The two concave notches 621 are latched and positioned by the ball 162 of the latch member 16.

The present invention further has a covering lid 70 covering the housing space 13 to seal the ratchet wheel 20, brake members 30, sliders 40 and the swinging bar 61 and position member 62 of the direction control member 60 in the housing space 13, while the turning strut 631 and action portion 22 run through the covering lid 70 and exposed outside the covering lid 70.

Referring to FIG. 4A, when the ratchet wrench of the present invention is in use, the stirring bar 63 can be turned rightwards to drive the position member 62 rightwards at the same time, and the concave notch 621 at the left side is latched by the ball 162 and positioned, and the right end of the swinging bar 61 is tilted upwards to push the slider 40 at the right side to move forwards and the elastic element 50 at the right side is compressed to push the brake member 30 to move forwards, and the ratchet teeth portion 31 at the front end of the brake member 30 is engaged with the ratchet wheel 20.

Thus the ratchet wheel 20 can turn clockwise and compress the brake member 30 at the right side to move rearwards, and the ratchet wheel 20 can also turn counterclockwise to be latched by the ratchet teeth portion 31 of the brake member 30 to produce brake effect. Therefore, the action portion 22 can be coupled with a working piece such as a sleeve (not shown in the drawings) and drive the sleeve to turn counterclockwise. Driving the sleeve clockwise is idled turning.

On the other hand, referring to FIG. 4B, when the stirring bar 63 is turned leftwards, the position member 62 also is moved leftwards at the same time, and the concave notch 621 at the right side is latched by the ball 162 and positioned, and the left end of the swinging bar 61 is tilted upwards to push the slider 40 at the left side to move forwards to compress the elastic element 50 at the left side to push the brake member 30 to move forwards, and the ratchet teeth portion 31 at the front end of the brake member 30 is engaged with the ratchet wheel 20.

Thus the ratchet wheel 20 can turn counterclockwise to compress the brake member 30 at the left side to move rearwards, and the ratchet wheel 20 can turn clockwise and be latched by the ratchet teeth portion 31 of the brake member 30 to produce the brake effect. Then the action portion 22 can be coupled with a working piece such as a sleeve (not shown in the drawings) and drive the sleeve to turn clockwise. Driving the sleeve counterclockwise is idled turning

As a conclusion, the present invention provides many advantages, notably:

1. By turning the stirring bar 63 leftwards or rightwards, the position member 62 and swinging bar 61 can be controlled to turn at the same time, and the position member 62 is butted by the ball 162 and positioned so that the brake member 30 at the right side is moved forwards to engage with the ratchet wheel 20, and the brake member 30 at the left side is moved concurrently rearwards to separate from the ratchet wheel 20; or the brake member 30 at the left side is moved forwards to engage with the ratchet wheel 20, and the brake member 30 at the right side is moved concurrently rearwards to separate from the ratchet wheel 20. Thus the operation is simple and a secure positioning can be accomplished. Direction switch can be achieved quickly to perform driving.

2. The position member 62 of the present invention has the concave notches 621 on the periphery butted by the ball 162 of the latch member 16 to provide positioning so that the swinging bar 61 can push the slider 40 at one side to move forwards. As the retaining slot 32 of the brake member 30 and the hook 41 of the slider 40 are still have extra space left, the brake member 30 can be compressed by the ratchet wheel 20 to move rearwards while the ratchet wheel 20 maintains a secured positioning condition. Thus one-way driving and turning operation can be accomplished definitely.

3. The ratchet wrench according to the present invention includes fewer elements and can be produced at a lower cost, thus product competitiveness improves.

What is claimed is:

1. A ratchet wrench, comprising:
a wrench body which comprises a handle portion at a rear side and an action end at a front side; the action end being annular and comprising a housing space formed thereon and two sliding troughs respectively located at two sides of the housing space and an elastically extensible latch member embedded axially at a rear side of the housing space;
a ratchet wheel which is held in the housing space and comprises a plurality of ratchet teeth formed on the circumference and an action portion jutting outwards;
two brake members which are elongated and held in the sliding troughs and comprise a ratchet teeth portion at a front side engageable with the ratchet wheel;
two block-shaped sliders which are held in the sliding troughs and hooked with the brake members, the sliders and the brake members being interposed by an axially extensible elastic element; and
a direction control member which comprises a swinging bar, an position member and a stirring bar located above the position member, the stirring bar comprising a turning strut located therebelow to run through the position member and the swinging bar, the swinging bar comprising two ends hinged on a rear side of the sliders, the position member being located between the swinging bar and the stirring bar and comprising two concave notches on the periphery to change directions with turning of the stirring bar such that the position member and the swinging bar are turnable together, the two concave notches being latched by the latch member for positioning.

2. The ratchet wrench of claim 1 further comprising a covering lid located on the top of the housing space to seal the ratchet wheel, the brake members, the sliders and the swinging bar and the position member of the direction control member inside, while the turning strut and the action portion being run through the covering lid and being exposed outside the covering lid.

3. The ratchet wrench of claim 1, wherein each of the sliders comprises a holding trough at the rear side, the swinging bar comprising bosses respectively located beneath two ends thereof to couple with the holding trough.

4. The ratchet wrench of claim 1, wherein each of the brake members comprises a retaining slot at a rear side with an opening directing upwards, each of the sliders comprising a hook corresponding to the retaining slot, the elastic element comprising one end embedded in the slider and the other end butting a rear wall of the retaining slot.

5. The ratchet wrench of claim 4, wherein the elastic element is a spring.

6. The ratchet wrench of claim 1, wherein the wrench body comprises a cavity at the rear side of the housing space to hold the latch member which comprises a ball and another elastic element extensible axially, the another elastic element being held in the cavity to push the ball partially exposed outside the housing space.

7. The ratchet wrench of claim 6, wherein the another elastic element is a spring.

8. The ratchet wrench of claim 1, wherein the action portion is a square strut.
